(19) United States
(12) Patent Application Publication
(10) Pub. No.: US 2007/0274485 A1
(43) Pub. Date: Nov. 29, 2007

(54) Network-independent ringback feature

(76) Inventor: William J. Garrison, Warminster, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/430,537

(22) Filed: May 9, 2006

(51) Int. Cl. H04M 15/06; H04M 1/56

(52) U.S. Cl. 379/142.01

(57) ABSTRACT

Audible and/or visible ringback signals are provided to a calling party by wired or wireless communication equipment in a local region associated with a called party, and not by the wide-area network(s) via which the calling party communicates with the called party. The non-network ringback signals are provided after a communication channel has been established between the calling party and the called party, but before the called party handles substantive communication content from the calling part. Non-network ringback signals may be selected based on various criteria, such as an identity of the calling party, capability of calling party communication equipment, or a type of information (for example, video, audio, or data) exchangeable via the communication channel.

### BACKGROUND

In circuit-switched wide-area communication networks, a physical path or a communication channel is dedicated to a connection between a calling party and a called party for the duration of a voice, video, or data communication. The public switched telephone network (“PSTN”) and some types of radio frequency communication networks (for example, certain cellular and satellite networks) are examples of circuit-switched wide-area communication networks. Generally, the calling party hears ringing tones or other messages provided by the communication network before a connection with the calling party is established. Ringing tones or other messages sent to a calling party to indicate that the called party is receiving a request to communicate are referred to as ringback signals.

A packet-switched wide-area network is any type of network or portion thereof that routes packets of data between a calling party and a called party based on a destination address associated with each packet. The same physical path may be shared by data packets having different destination addresses. The Internet is one example of a packet-switched network. Internet Protocol (“IP”) is a protocol used with the Internet and other packet-switched networks to send packets of data between devices having destination addresses known as IP addresses. When packet-switched wide-area networks are used for telecommunications (for example, to make voice-over IP calls), it may be desirable for wide-area networks to reproduce certain familiar features of circuit-switched calls, such as providing ringback signals to calling parties.

Consumers of all types of wide-area networks generally appreciate customizable product and service features. Some wide-area network operators have offered or proposed services that allow called parties to customize network-provided ringback signals provided to calling parties. Like standard ringing tones, the custom tones or messages are provided by the wide-area network before physical or virtual connections are established between the calling party and the called party.

The availability of custom network-provided ringback signals, however, may be subject to limitations imposed by the networks. For example, consumers may be offered limited choices of ringback signals, or custom ringback signals may have reduced availability when the called party is roaming outside of his or her home network.

A feature that allows a called party to provide custom ringback experiences to calling parties in a network-independent manner via equipment local to the called party could enhance consumer satisfaction with, and investment in, communication equipment and services usable with various types of wide-area networks, by providing virtually unlimited, flexible, user-specifiable choices for ringback signal customization and availability.

### BRIEF DESCRIPTION OF THE DRAWINGS

FIG. 1 is a simplified functional block diagram of a communication architecture over which communications between a calling party and a called party can occur.

FIG. 2 is a message sequence chart illustrating certain aspects of a method for establishing communication between the calling party and the called party shown in FIG. 1, via the communication architecture shown in FIG. 1.

FIG. 3 is a message sequence chart illustrating certain aspects of a method for providing a non-network ringback signal to the calling party shown in FIG. 1, via the communication architecture shown in FIG. 1.

FIG. 4 is a simplified functional block diagram of an exemplary configuration of a called party communication device, with which aspects of the method illustrated in FIG. 3 may be used.

### DETAILED DESCRIPTION

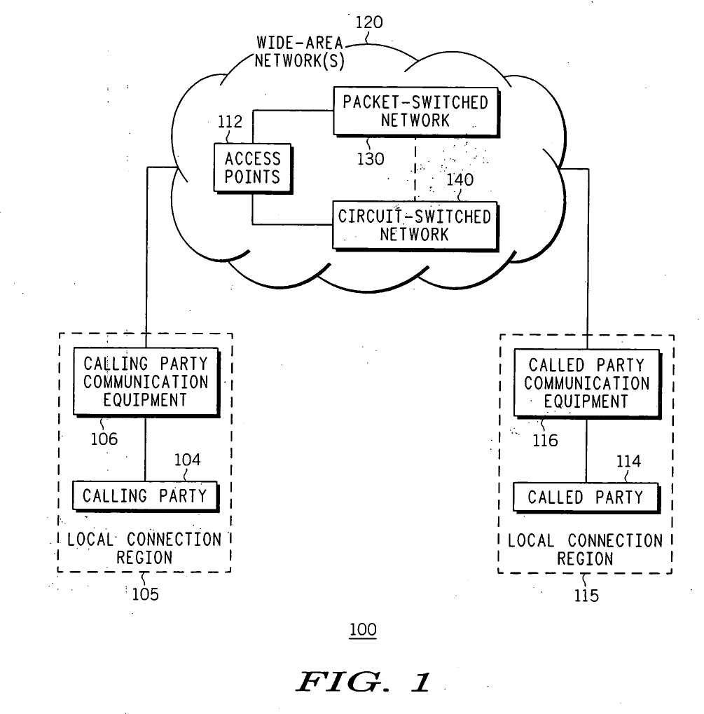

Turning to the drawings, where like numerals designate like components, FIG. 1 is a simplified functional block diagram of a communication architecture 100, over which various types of communications (for example, audio, video, and data) between a calling party 104 and a called party 114 can occur. Calling party 104 is an entity (a person or business) on behalf of which a communication is initiated. Called party 114 is an entity to which communication from calling party 104 is directed.

Wide-area network(s) 120 represent one or more geographically dispersed networks, generally covering geographic regions of more than a few hundred meters. As shown, wide-area network(s) 120 include a packet-switched network 130 and a circuit-switched network 140.

Packet-switched network 130 represents any type of network or portion thereof that routes packets of data between calling party 104 and called party 114 based on a destination addresses of the calling party or the called party. The Internet is one an example of a packet-switched network. Internet Protocol (“IP”) is a protocol used with both the Internet and other packet-switched networks to send packets of data between devices having destination addresses known as IP addresses.

Circuit-switched network 140 represents any type of network or portion thereof in which a physical path or a communication channel is dedicated to a connection between calling party 104 and called party 114. Examples of circuit-switched networks are the public switched telephone network (“PSTN”) and radio frequency communication networks such as certain cellular or satellite communication networks.

Wide-area networks 120 are accessed, directly or indirectly, by calling party communication equipment 106 via access points 112. An access point is a physical or logical element that provides the first point of entry into infrastructure or services associated with a particular wide-area network. Examples of access points 112 include but are not limited to physical or logical access nodes such as cable access nodes (for example, cable modem termination systems), PSTN access nodes (for example, switches), DSL access nodes, wireless access nodes (for example, cellular or satellite transceiver equipment), or IP network access nodes (for example, packet data switches). It will be appreciated that various protocols and standards (not shown) may be used for communication via different types access nodes.

Calling party communication equipment 106 operates within a local connection region 105 to facilitate the transmission or receipt of information on behalf of calling party 104 via wide-area network(s) 120. Calling party communication equipment 106 includes any wired or wireless electronic device, or any physical or logical element thereof, either standing alone or included in other devices, that is responsive to calling party 104 within local connection region 105.

Called party communication equipment 116 operates within a local connection region 115 to facilitate the transmission or receipt of information on behalf of called party 114 via wide-area network(s) 120. Called party communication equipment 116 includes any wired or wireless electronic device, or any physical or logical element thereof, that is responsive to called party 114 within local connection region 115.

Local connection regions 105 and 115 may be defined geographically, functionally, or a combination thereof. An example of a geographical region is a relatively small physical area (for example, up to a few hundred meters) surrounding a party. Examples of functional regions include physical or logical connections or elements, which are not part of wide-area network(s) 120, used by a party to communicate with wide-area network(s) 120.

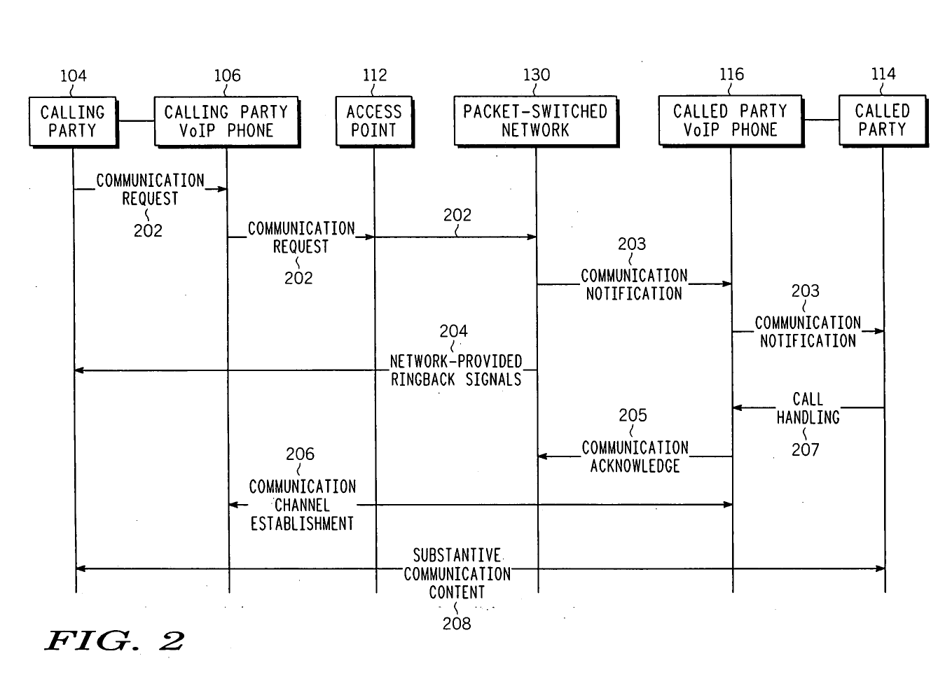

With continuing reference to FIG. 1, FIG. 2 is a simplified message sequence chart 200 illustrating aspects of a method for establishing communication between calling party 104 and called party 114 via wide-area network(s) 120. For discussion purposes, calling party communication equipment 106 and called party communication equipment 116 are shown as wired or wireless voice-over IP (“VoIP”) phones, with audio and video capabilities. VoIP is used as a generic term for the transport of, and protocols for the transport of, audio, video, or data calls over Internet Protocol (“IP”) networks. Such IP networks may be private networks, such as networks operated by cable television or telecommunication providers, or public networks, such as the Internet, or any combination thereof. As shown, packet-switched network 130 is an IP network that handles VoIP traffic and provides VoIP services to subscribers such as calling party 104 and called party 114.

Initially, calling party 104 and/or calling party VoIP phone 106 attempts to register with packet-switched network 130 by sending a communication request message 202 via access point 112. Communication request message 202 is an out-of-band or in-band signal transmitted, using any suitable signaling protocol, by or on behalf of calling party 104 for the purpose of establishing communication with called party 114 via packet-switched network 130. For example, communication request message 202 may be a service request message, such as a domain name system query or another type of query.

Based on communication request message 202, packet-switched network 130 may perform the step (not shown) of granting or denying calling party VoIP phone 106 access to the wide-area network(s). For example, among other things, various authentication, authorization, and accounting (“AAA”) activities may be performed by or on behalf of packet-switched network 130 before calling party 104 is authorized to access the packet-switched network to communicate with called party 114.

AAA activities have been defined and standardized by the Internet Engineering Task Force (“IETF”). A common signaling protocol used with VoIP calls is Session Initiation Protocol (“SIP”), which is standardized by the IETF. Authentication is the process of identifying a user. Authorization is the process of enforcing policies, determining what types or qualities of activities, resources, or services the user is permitted to use. Authentication may also encompass the authorization process. In the process of authentication, for example, certain service profiles (information regarding approved services and service options, such as voicemail greetings, network-provided ringback signals 204, call forwarding information, and the like) may be established. Accounting measures the billable resources a user accesses during use of a particular network or service.

Once calling party VoIP phone 106 is granted access to packet-switched network 130, called party VoIP phone 116 and called party 114 are notified, via communication notification message 203, of the attempt by calling party 104 to contact called party 114. Communication notification message 203 represents any message, method, or technique usable to directly or indirectly notify called party 114 or called party VoIP phone 116 that calling party 104 has initiated communication with called party 114 via packet-switched network 130.

Next, network-provided ringback signals 204 are transmitted by or on behalf of packet-switched network 130 to calling party VoIP phone 106, and received by calling party 104. Network-provided ringback signals 204 are audible or visible signals provided by or on behalf of packet-switched network 130. Network-provided ringback signals 204 are transmitted before called party 114 or called party VoIP phone 116 consents to the establishment of a communication channel 206.

Communication channel 206 represents a bidirectional physical or logical connection over wide-area network(s) 120, between calling party communication equipment, such as calling party VoIP phone 106, and called party communication equipment, such as called party VoIP phone 116. One example of a logical connection is a packet data tunnel. Examples of physical connections are frequency division multiple access (“FDMA”) communication channels, time division multiple access (“TDMA”) communication channels, and code division multiple access (“CDMA”) communication channels.

One way in which called party 114 may consent to the establishment of communication channel 206 is by performing one or more call handling acts 207. For example, called party 114 may answer the call, or the call may be handled by certain called party communication equipment (or the packet-switched network) by playing an automated greeting and providing an opportunity for the calling party to transmit a message. VoIP phone 116 transmits communication acknowledge message 205 in response to call handling acts 207. Communication acknowledge message 205 is any message, method, or technique usable to directly or indirectly notify packet-switched network 130 that called party 114 consents to the establishment of communication channel 206.

Generally, when communication channel 206 is established, network-provided ringback signals 204 are stopped, and substantive communication content 208 is exchanged. Substantive communication content 208 is any combination of video, audio or data content communicated via communication channel 206 that represents an essential purpose of the communication between calling party 104 and called party 114. In the context of a VoIP call, substantive communication content 208 may be the information carried by data packets sent between calling party VoIP phone 106 and called party VoIP phone 116 based on the destination IP addresses of the called party communication equipment 116 and calling party communication equipment 106, respectively.

With continuing reference to FIGS. 1 and 2, FIG. 3 is a message sequence chart illustrating certain aspects of a method, usable with communication architecture 100 (shown in FIG. 1), by which called party communication equipment 116 is used to provide a non-network ringback signal 312 to a calling party 104 and/or calling party communication equipment 106 via wide-area network(s) 120. In one exemplary system, calling party communication equipment 106 and called party communication equipment 116 are VoIP phones with video and audio capability, and wide-area network(s) 120 includes packet-switched network 130 over which a VoIP service is operated.

Initially, calling party 104 causes a communication request message 302 to be sent via communication equipment 106. For example, calling party communication equipment 302 attempts to register with wide-area network(s) 120 by sending a communication request message 302 via access point 112. Like communication request message 202 (shown in FIG. 2), communication request message 302 is an out-of-band or in-band signal transmitted, using any suitable signaling protocol, by or on behalf of calling party 104 for the purpose of establishing communication with called party 114 via wide-area network(s) 120. For example, communication request message 202 may be a service request message, such as a domain name system query or another type of query, sent by the calling party VoIP phone to the packet-switched network. Communication request message 202 may contain or refer to caller ID information or other information about calling party communication equipment 106 or the type of communication desired with called party 114 (video, audio, or data, for example).

Based on communication request message 302, wide-area network(s) 120 may perform the step (not shown) of granting or denying calling party equipment 106 access to the wide-area network(s). For example, among other things, various AAA activities may be performed by or on behalf of wide-area network(s) 120 before calling party 104 is authorized to access the wide-area network(s) to communicate with called party 114.

Once calling party equipment 106 is granted access to wide-area network(s) 120, called party communication equipment 116 and called party 114 are notified, via communication notification message 303, of the attempt by calling party communication equipment 106 to contact called party 114. Like communication notification message 203 (shown in FIG. 2), communication notification message 303 represents any message, method, or technique usable to notify called party communication equipment 116 or called party 114 that calling party 104 has initiated communication with called party 114 via wide-area network(s) 120. For example, a standard VoIP message may be used.

Next, called party communication equipment 116 automatically notifies wide-area network(s) 120, via communication acknowledge message 305, of consent to the establishment of a communication channel 306 with calling party communication equipment 106. Communication acknowledge message 305 is any message, method, or technique usable to directly or indirectly notify wide-area network(s) 120 that called party 114 or called party communication equipment 116 consents to the establishment of communication channel 306. No action by called party 114 is required. One type of communication acknowledge message 305 may indicate that called party 114 or called party communication equipment 116 is handling the incoming call, resulting in the establishment of communication channel 306. It is generally desirable, but not necessary, for communication acknowledge message 305 to be transmitted to calling party communication equipment 106 before wide-area network(s) 120 have the opportunity transmit network-provided ringback signals 204 (shown in FIG. 2).

Like communication channel 206, communication channel 306 represents a bidirectional physical or logical connection over wide-area network(s) 120, between calling party communication equipment 104 and called party communication equipment 116.

Next, rather than called party 114 performing call handling acts 307 (for example, speaking or playing an automated greeting and providing an opportunity for the calling party to transmit a message), called party communication equipment 116 first selects and transmits non-network ringback signal 312 to calling party communication equipment 106 and/or calling party 104. It is generally desirable, but not necessary, for non-network ringback signals 312 to be transmitted to calling party communication equipment 106 before wide-area network(s) 120 have the opportunity transmit network-provided ringback signals 204.

Non-network ringback signals 312 are audible or visible signals that may originate from one or more sources. Examples of non-network ringback signals 312 include, among other things, video samples, audio samples, graphics, text, and combinations thereof. A source is any device, location, or data from which non-network ringback signals 312 are derived or obtained. Alternatively, to avoid charges associated with establishing connections for certain calls, users may define (when creating an electronic phone book, for example) which calling parties will receive network-provided ringback signals 204, and to allow network-provided ringback signals 204 to be transmitted to those parties.

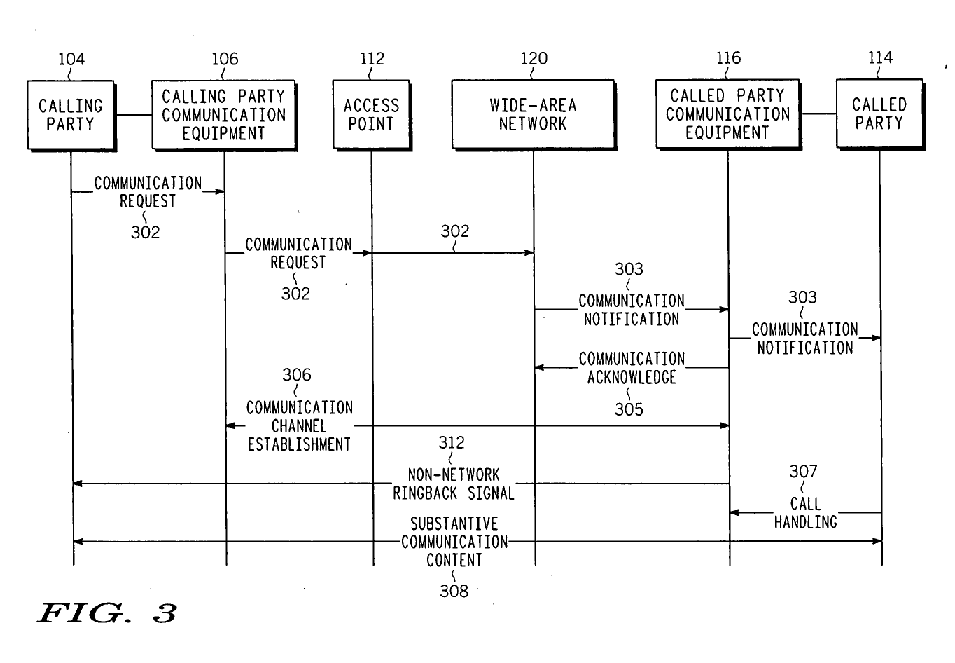

Non-network ringback signals are selectable using various criteria, such as an identity of the calling party or a type of information (for example, video, audio, or data) exchangeable via the communication channel. For example, in the context of FIG. 3, rather than called party 114 answering the call or playing an automated greeting and providing an opportunity for calling party 104 to transmit a message to called party 114, called party communication equipment 116, such as a VoIP phone, may identify calling party 104 based on the caller ID of (or other information associated with) calling party communication equipment 106, select a particular non-network ringback signal 312 (such as an MP3 file of a dog barking, a song, or a car engine revving) from local or remote storage, and transmit the selected non-network ringback signal 312 to calling party 104, after establishment of communication channel 306. If calling party communication equipment 106 supports video, then video clips could be played (for example, a video of someone racing down the stairs to get the phone might be appropriate). If the non-network ringback signal is transmitted to the calling party before network-provided ringback signals 204 are transmitted, the establishment of communication channel 306 may not be obvious to calling party 104. It is not necessary that non-network ringback signal 312 be periodic. A continuous ringback signal 312 (for example, one or more audio or video samples) may be used.

Users can pre-define (when creating an electronic phone book, for example) the non-network ringback signals 312 that will be received by particular calling parties. Alternatively, users can select particular non-ringback signals 312 at the time communication request 303 is received.

Like network-provided ringback signals 204, non-network ringback signals 312 indicate to calling party 104/calling party communication equipment 206 that the called party is not yet ready to handle substantive communication content 308 from the calling party. Unlike network-provided ringback signals 204, however, non-network ringback signals 312 are custom signals provided by or on behalf of called party communication equipment 116, not by wide-area network(s) 120.

When called party 114 is ready to handle substantive communication content 308 from calling party 104, called party 114 performs one or more call handling acts 307, such as answering the call, or playing an automated greeting and providing an opportunity for the calling party to transmit a message. Once called party 114 performs one or more call handling acts 307, or calling party 104 terminates communication, whichever occurs first, called party communication equipment 116 stops transmitting non-network ringback signals 312.

The non-network ringback feature described herein enables called parties to provide custom ringback experiences to calling parties in a network-independent manner using their own communication equipment. Called parties would have virtually unlimited, flexible, user-specifiable choices for customization and availability of ringback signals, and would not be subject to selection or availability limitations imposed by network providers. Non-network ringback signals could enhance consumer satisfaction with, and investment in, communication equipment and services operable with many types of wide-area networks. Manufacturers may realize larger market share by offering such consumer-friendly features on certain communication equipment. Even calling parties could realize advantages not present with network-provided ringback signals, such as being alerted to potential problems, such as power failures or equipment loss, when network-provided ringback signals are received instead of expected non-network ringback signals.

Although the ringback feature described herein is usable with any type of wide-area network, it is particularly well suited for use in packet-data networks that provide VoIP services. VoIP makes certain things easier that are more difficult with traditional phone networks. For example, incoming phone calls can be routed wherever communication equipment is connected to the Internet, and VoIP phones can integrate with other Internet-based services, such as video phone services, audio conference services, and data services. VoIP subscribers generally pay a flat fee for VoIP services, rather than paying on a per-call basis. The establishment of communication channels for the purpose of transmitting non-network ringback signals would not necessarily result in additional service fees.

Certain aspects of the message sequence chart shown in FIG. 3 may be implemented as a method in a general, multi-purpose or single-purpose processor. Such a processor will execute instructions, either at the assembly-, compiled- or machine-level, to perform that method. The instructions can be written by one of ordinary skill in the art following the description of FIG. 3 and stored or transmitted on a computer-readable medium, such as computer-readable medium 404. The instructions may also be created using source code or any other known computer-aided design tool.

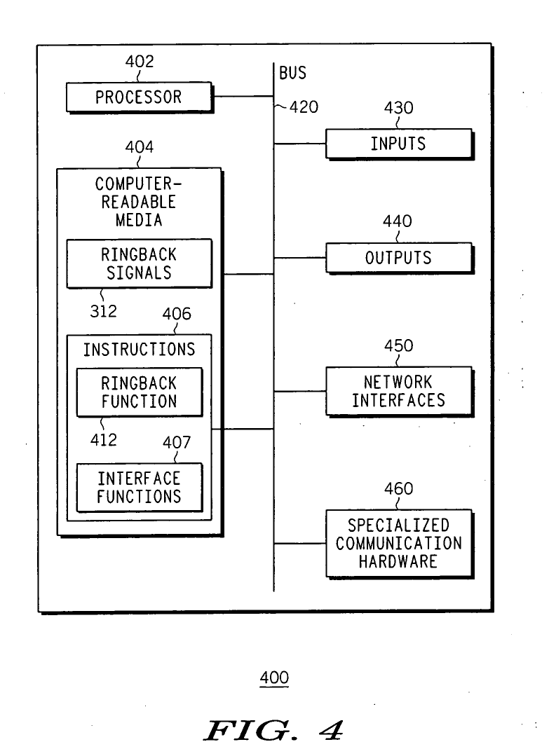

With continuing reference to FIGS. 1-3, FIG. 4 is a block diagram of an operating environment 400 with which certain aspects of the method shown in FIG. 3 may be used. Operating environment 400 includes certain functional components that may be used to implement, may be accessed by, or may be included in, called party communication equipment, such as called party communication equipment 116, to provide non-network ringback signals 312 to a calling party, such as called party 114.

In one implementation, operating environment 400 (or portions thereof) are included in a VoIP phone. In other implementations, operating environment 400 may be included in other called party equipment, such as gateways, local routers, and end-user communication devices. Examples of end-user communication devices are wired or wireless phones (such as traditional phones, cellular phones, satellite phones, VoIP phones, or video phones), pagers, personal digital assistants, computers, modems, monitoring devices or systems (for example, home alarm systems), or media systems (for example, cable or satellite set-top boxes, video players or audio players).

Operating environment 400 includes a processor 402, computer-readable media 404 (on which non-network ringback signals 312 and instructions 406 may be stored), instructions 406 (which implement interface functions 407 and non-network ringback function 412, among other functions), a bus 420, inputs 430, outputs 440, network interfaces 450, and specialized communication hardware 460.

Processor 402, which may be a real or a virtual processor, controls functions of operating environment 400 by executing instructions 406. Processor 402 is responsive to computer-readable media 904 and to instructions 406 via bus 420. Bus 420 represents one or more well-known and widely available elements used to carry data, addresses, control signals and other information within, to, or from operating environment 400 or elements thereof.

Computer-readable media 404 represents any number and combination of local or remote, removable or non-removable, volatile or non-volatile devices, in any form, now known or later developed, capable of recording or storing computer-readable data. Non-network ringback signals 312 and instructions 406 are stored on one or more types of computer-readable media 404. Non-network ringback signals 312 may be stored using various formats or protocols, such as portable network graphics (“PNG”), joint photographic experts group (“JPEG”), moving picture experts group (“MPEG”), multiple-image network graphics (“MNG”), audio video interleave (“AVI”), extensible markup language (“XML”), hypertext markup language (“HTML”), extensible HTML (“XHTML”), MP3, and WAV.

Computer-readable media 404 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk (“CD”) or DVD); a bubble memory; a cache memory; a core memory; a holographic memory; a memory stick; a paper tape; a punch card; or any combination thereof. Computer-readable media 404 may also include transmission media and data associated therewith. Examples of transmission media/data include, but are not limited to, data embodied in any form of wireline or wireless transmission, such as packetized or non-packetized data carried by a modulated carrier signal.

Instructions 406 represent any signal processing methods or stored instructions that electronically control predetermined operations on data. In one instance, instructions 406 are computer-executable instructions implemented as software components according to well-known practices for component-based software development, and encoded in one or more computer-readable media 404. Computer programs may be combined or distributed in various ways. Instructions 406, however, are not limited to implementation by any specific embodiments of computer programs, and in other instances may generally be implemented by, or executed in, hardware, software, firmware, or any combination thereof.

Ringback function 412 represents the instructions that provide the mechanism by which called party communication equipment 116 selects and transmits particular non-network ringback signals 312 to calling party 104 and/or calling party communication equipment 106, as described herein. Generally, ringback function 412 is implemented as a software application operable with one or more items of party communication equipment 116.

Interface functions 407 represent the instructions required to implement network interfaces 450. For example, data packets traveling between devices such as VoIP phones, and devices that implement VoIP functions within packet-switched networks, pass through, at each network interface, one or more of the seven vertical layers of the well-known abstract model that defines internetworking (the “Internetworking Model”): layer 1, the Physical Layer; layer 2, the Data Link Layer; layer 3, the Network Layer; layer 4, the Transport Layer; layer 5, the Session Layer; layer 6, the Presentation Layer; and layer 7, the Application Layer. Based on the particular operating environment 400, interface functions 407 may be implemented at one or more layers of the Interworking Model.

Inputs 430 provide input to operating environment 400. Input may be collected using any type of now known or later-developed interface, such as a user interface. User interfaces may be touch-input devices such as remote controls, displays, mice, pens, styluses, trackballs, keyboards, microphones, scanning devices, and all types of devices that are used to input data.

Outputs 440 provide output from operating environment 400 using any type of now known or later-developed output interface. Examples of output interfaces include displays, printers, speakers, disk drives and the like.

Network interfaces 450 are available to enhance the ability of operating environment 400 to receive information from, or to transmit information to, another entity via a communication medium such as a channel signal, a data signal, or a computer-readable medium. Network interfaces 450 may be, or may include, elements such as modems, data terminal equipment, media players, data storage devices, communication cards, or any other device or component thereof, along with associated network support devices, software, or interfaces.

Specialized communication hardware 460 represents any hardware or firmware, now known or later developed, that is responsive to transmit or receive electronic information via wide-area network(s) 120 on behalf of called party 114. Examples of specialized communication hardware 460 include encoder/decoders (“CODECs”), application-specific integrated circuits, and the like.

An exemplary, functional configuration of called party communication equipment 116 has been described in the context of operating environment 400. Operating environment 400, however, is only one example of a suitable operating environment and is not intended to suggest any limitation as to the scope of use or functionality of the non-network ringback feature described herein. For example, it will be appreciated that a particular configuration of called party communication equipment 116 may include fewer, more, or different components or functions than those described. In addition, functional components of communication equipment 116 may be implemented by one or more devices, co-located or remotely located, in a variety of ways. It will also be understood that all of the foregoing components need not be used, nor must the components, when used, be present concurrently.

Although VoIP has been described as a service implemented via a packet-switched network that would benefit from the use of the non-network ringback signal feature(s) described herein, it will be understood that any telephony or non-telephony communication networks or services now known or later developed may benefit from the use of the subject matter described herein. It will also be appreciated that the claimed subject matter is not limited to implementations that solve any or all of the disadvantages of specific wide-area networks, communication equipment, or aspects thereof.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims. Unless specifically stated, the methods described herein are not constrained to a particular order or sequence. In addition, some of the described method or elements thereof can occur or be performed concurrently.

When one element is indicated as being responsive to another element, the elements may be directly or indirectly coupled. Connections depicted herein may be logical or physical in practice to achieve a coupling or communicative interface between elements. Connections may be implemented as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

1. A communication device, comprising:
a network interface that receives a communication request; and
a processor responsive to computer-executable instructions, so that the processor is operative to:
in response to the communication request, establish a communication channel over a wide-area network;
select a ringback signal usable to indicate that a called party is not ready to handle substantive communication content from a calling party, the ringback signal not controlled by the wide-area network; and
prior to the called party handling substantive communication content from the calling party, transmit the selected ringback signal via the communication channel.

2. The communication device according to claim 1, further comprising:
a memory responsive to the processor and to the computer-executable instructions, the memory having a data structure stored thereon, the data structure comprising
an identification information field for storing identification information associated with a plurality of calling parties, and
a ringback signal field for storing a plurality of ringback signals,
the selection of the ringback signal by the processor made from the plurality of ringback signals based on identification information associated with the calling party.

3. The communication device according to claim 2, wherein the identification information is transmitted via the communication request.

4. The communication device according to claim 2, wherein the identification information associated with the plurality of calling parties is selected from the group consisting of: caller ID information, call type information, and communication equipment capability.

5. The communication device according to claim 2, wherein the plurality of ringback signals are selected from the group consisting of: continuous signals and periodic signals.

6. The communication device according to claim 1, wherein the communication device comprises one of a wireless phone, a wireline phone, a voice-over-IP phone, and a video phone.

7. The communication device according to claim 1, wherein the communication device comprises a personal computing device, a router, a modem, a media system, and a monitoring device.

8. A method for communication handling, the method comprising:
receiving a communication request;
in response to the communication request, establishing a communication channel over a wide-area network between equipment associated with a called party and equipment associated with a calling party;
selecting a ringback signal, the ringback signal usable to indicate to the calling party that the called party is not ready to handle substantive communication content from the calling party, the ringback signal not controlled by the wide-area network; and
prior to the called party handling substantive communication content from the calling party, transmitting the selected ringback signal via the communication channel.

9. The method according to claim 8, further comprising:
while the selected ringback signal is being transmitted to the calling party, providing one of an audible and a visible indicator to the called party.

10. The method according to claim 7, further comprising:
ascertaining information associated with the calling party.

11. The method according to claim 10, wherein the step of arranging for selection of a ringback signal comprises arranging for selection of a ringback signal based on the information associated with the calling party.

12. The method according to claim 11, wherein the information associated with the calling party comprises one of caller ID information, call type information, and a capability of the equipment associated with the calling party.

13. The method according to claim 11, wherein the information associated with the calling party is ascertained from the communication request.

14. The method according to claim 8, wherein the ringback signal is selected by the called party communication equipment.

15. The method according to claim 8, wherein the wide-area network comprises a circuit-switched network.

16. The method according to claim 8, wherein the wide-area network comprises a packet-data network.

17. The method according to claim 16, wherein the step of establishing the communication channel between equipment associated with the called party and equipment associated with the calling party comprises establishing a packet data tunnel via the packet-data network.

18. The method according to claim 17, wherein the packet data tunnel is established using a voice-over-IP protocol.

19. A computer-readable medium having instructions executable by a processor, which perform a method comprising:
receiving a communication request;
in response to the communication request, establishing a communication channel over a wide-area network between communication equipment associated with a calling party and communication equipment associated with a called party;
selecting a ringback signal usable to indicate that the called party is not ready to handle substantive communication content from the calling party, the ringback signal not controlled by the wide-area network; and
prior to the called party handling substantive communication content from the calling party, transmitting the selected ringback signal via the communication channel.

20. The computer-readable medium according to claim 19, wherein the computer-readable medium is within the communication equipment associated with the called party.
